(19) United States
(12) Patent Application Publication
(10) Pub. No.: US 2017/0365097 A1
(43) Pub. Date: Dec. 21, 2017

(54) SYSTEM AND METHOD FOR INTELLIGENT TAGGING AND INTERFACE CONTROL

(71) Applicant: MOTOROLA SOLUTIONS, INC., Schaumburg, IL (US)

(72) Inventors: Bing Qin Lim, Jelutung (MY); Chee Kit Chan, Ipoh (MY); Boon Kheng Hooi, Alor Star (MY); Wai Mun Lee, Penang (MY)

(21) Appl. No.: 15/186,690

(22) Filed: Jun. 20, 2016

(51) Int. Cl. G06T 19/00; G06F 3/0488; G06F 3/0484; G06T 11/60; G06F 3/0481

(52) U.S. Cl. CPC G06T 19/006; G06T 11/60; G06F 3/04817; G06F 3/04842; G06F 3/0488

(57) ABSTRACT

A system and method for communicating with an augmented reality display system. The method includes generating, with an electronic processor, a first image at the augmented reality display system, the augmented reality display system including a field-of-view. The method further includes generating a second image on a portable electronic device. The method further includes positioning the portable electronic device within the field-of-view of the augmented reality display system. The method further includes capturing the second image, by an image sensor, at the augmented reality display system. The method further includes displaying the second image overlaid on the first image.

### BACKGROUND

Augmented reality display systems provide a live direct or indirect view of a physical, real-world environment whose elements are augmented by computer-generated input such as sound, text, video, graphics, etc. Augmented reality display systems may include devices such as head-mounted displays (HMD), augmented reality helmets, eye glasses, goggles, digital cameras, and other portable electronic display devices that may display images of both the physical world and virtual objects over the user's field-of-view. The use of augmented reality display systems by emergency response personnel may become more prevalent in the future. Interacting with and controlling such augmented reality display systems during mission critical situations may create new challenges. A user interface that can provide an optimal user experience with improved situation awareness is desired.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communication system in accordance with some embodiments.

FIG. 2 is a block diagram of the augmented reality display system in accordance with some embodiments.

FIG. 3 illustrates a set of icons, in accordance with some embodiments.

FIG. 4 illustrates a set of hand-drawn icons, in accordance with some embodiments.

FIG. 5A illustrates an icon displayed on a wrist worn electronic device, in accordance with some embodiments.

FIG. 5B illustrates a field-of-view of an augmented reality display system displaying a map, in accordance with some embodiments.

FIG. 5C illustrates tagging of the icon shown in FIG. 5A on the map shown in FIG. 5B, in accordance with some embodiments.

FIG. 5D illustrates the map displayed in FIG. 5B having the icon shown in FIG. 5A tagged on the map, in accordance with some embodiments.

FIG. 6 illustrates repositioning of the icon shown in FIG. 5A in the field-of-view of an augmented reality display system, in accordance with some embodiments.

FIG. 7 illustrates resizing of the icon shown in FIG. 5A in the field-of-view of an augmented reality display system, in accordance with some embodiments.

FIG. 8 is a flow chart of a method of communicating with an augmented reality display system of FIG. 2, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One exemplary embodiment provides a method of communicating with an augmented reality display system that includes generating, with an electronic processor, a first image at the augmented reality display system, the augmented reality display system including a field-of-view; generating a second image on a portable electronic device; positioning the portable electronic device within the field-of-view; capturing the second image at the augmented reality display system; and displaying the second image overlaid on the first image.

Another exemplary embodiment provides an augmented reality display system that includes a display configured to display a first image on a field-of-view; an image sensor configured to capture a second image visible within the field-of-view of the display, the second image generated external to the display; and an electronic processor configured to display the second image overlaid on the first image.

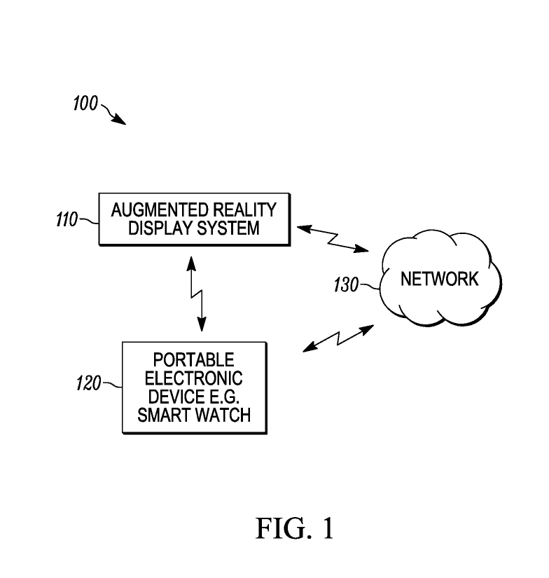

FIG. 1 is a block diagram of a communication system 100 in accordance with some embodiments. In the example illustrated, the communication system 100 includes an augmented reality display system 110, a portable electronic device 120 and a network 130. In an example, the augmented reality display system 110 is configured to wirelessly communicate with portable electronic device 120 and the network 130. In some embodiments, the portable electronic device 120 may be a wearable electronic device such as a wrist worn electronic device (for example, a smart watch). In alternative embodiments, the augmented reality display system 110 may be a head mounted display system, a helmet display, an electronic eye glass, display goggles, or a wearable digital display. In alternative embodiments, the portable electronic device 120 may be a smart telephone, a mobile radio, a tablet computer, a wireless controller, a hand held electronic device, or a digital camera.

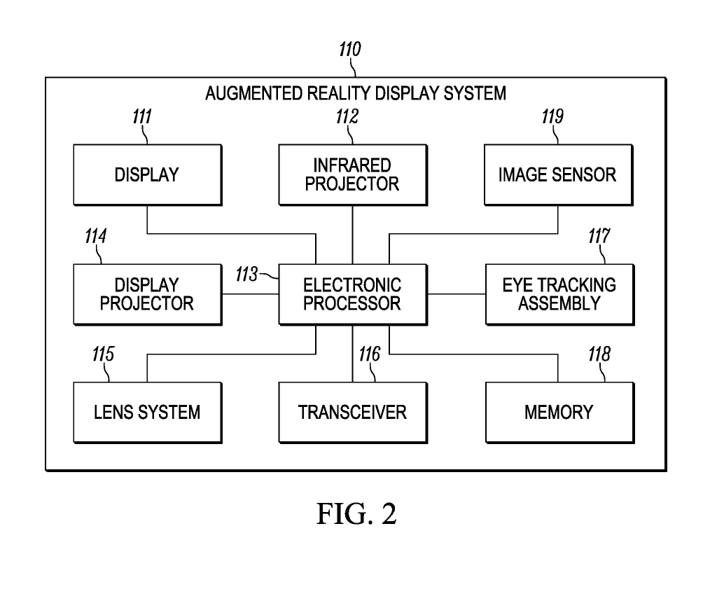

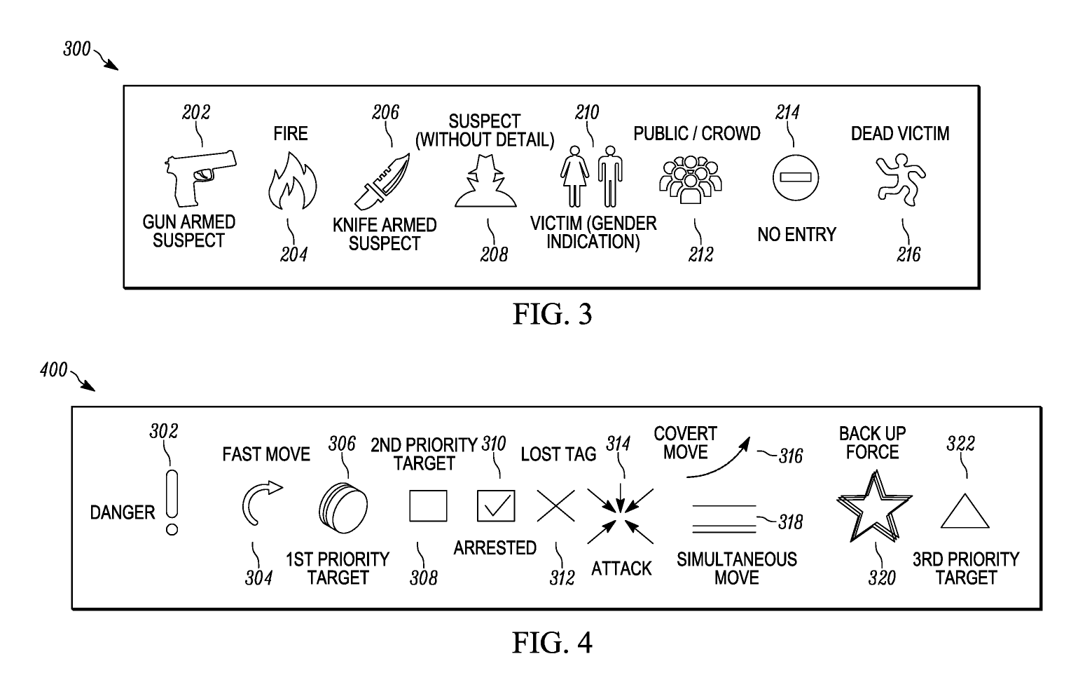

FIG. 2 is a block diagram of an augmented reality display system 110 in accordance with some embodiments. In the example illustrated, the augmented reality display system 110 includes a display device 111, an infrared projector 112, display projector 114, lens system 115, transceiver 116, an eye tracking assembly 117, a memory 118, and an image sensor 119 coupled to an electronic processor 113. The augmented reality display system 110 may have either one or two display devices 111 and may be worn by a user such that the eyes of the user are able to look through the lens system 115. In some embodiments, the eye tracking assembly 117 may be optional and may include an eye tracking camera. In some embodiments, the infrared projector 112 projects infrared light at the eyes of a user which allows the eye tracking assembly 117 to track a direction of the user's eyes (that is, tracking where the user is directing his or her gaze). In some embodiments, for example, the infrared projector 112 is coaxial with an optical path of the eyes (for example, bright pupil eye tracking). In other embodiments, the infrared projector 112 is offset with the optical path of the eyes (for example, dark pupil eye tracking). In some embodiments, augmented reality display system 110 includes more than one infrared projector 112 and eye tracking assembly 117. In some embodiments, the image sensor 119 is used to detect and locate the portable electronic device 120 either by detecting a unique image identifier (for example, an image pattern); a modulated or -unmodulated infrared emission; or by using a reflected infrared signal that is projected by the infrared projector 112. In some embodiments, the image sensor 119 is configured to identify icons (shown in FIG. 3 and FIG. 4) displayed on a portable electronic device.

The electronic processor 113 controls the display projector 114 to display images on the lens system 115. This description of the display projector 114 and the lens system 115 is exemplary and should not be considered as restricting. For example, in alternative embodiments, the lens system 115 itself may be capable of displaying images. In some embodiments, a flexible organic light-emitting diode (OLED) display may be used to display images. Images displayed with the display projector 114 and the lens system 115 may be displayed at a predetermined location within a field-of-view of the user. Additionally, the electronic processor 113 controls the display projector 114 to display an image on the lens system 115 such that the image appears to be at a predetermined focal distance from the user.

For example, an image may be displayed such that it would appear to be in focus to a user focusing his or her vision at a distance of one (1) meter. However, that same image would appear to be out of focus to a user who was focusing his or her vision at another focal distance (for example, three (3) meters). In some embodiments, the augmented reality display system 110 includes more than one display projector 114 (that is, each lens of the lens system 115 may have a separate display projector 114). The display projector 114 may display images in various ways that are perceivable to the eyes of the user (that is, text, icons, images, etc.).

The transceiver 116 may send data from the augmented reality display system 110 to another device such as the portable electronic device 120. The transceiver 116 may also receive data from another device such as the portable electronic device 120. The electronic processor 113 may receive data from the transceiver 116 and control the display projector 114 based on the received data. For example, the transceiver 116 may receive, from a mobile or portable communication device, a notification that is to be displayed to the user. The notification may be received by the transceiver 116 as a result of the portable communication device receiving information such as an incoming telephone call, text message, image, etc. The electronic processor 113 may control the display projector 114 to display the notification received by the transceiver 116 to the user, as will be described in more detail below. The transceiver 116 is exemplary. Other embodiments include other types of transceivers including, but not limited to, radio frequency modems, frequency modulation two-way radios, long-term evolution (LTE) transceivers, code division multiple access (CDMA) transceivers, Wi-Fi (that is, IEEE 802.11x) modules, etc.

FIG. 3 illustrates a set 300 of icons that may be used for tagging an image (for example a map of an environment associated with a user) displayed on the augmented reality display system 110, in accordance with some embodiments. In an example, such as during an emergency operation, a user of an augmented reality display system 110 may select, tag, and communicate the icons shown in set 300 to the rest of the emergency-response team, described in more detail below. For example, the user may select the icon 202 to indicate the presence of an armed individual carrying a gun; the icon 204 to indicate the presence of fire or in a particular area; the icon 206 to indicate the presence of an armed individual carrying a knife; the icon 208 to represent a suspect without any additional details; the icon 210 to indicate the gender of a victim; the icon 212 to indicate the presence of a crowd; the icon 214 to convey “No Entry”; the icon 216 to indicate the presence of a dead victim at a location. In some embodiments, the icons may be pictures of team members. In some embodiments the icons may be names of team members or names of various teams. The icons (shown in FIG. 3) may be tagged onto the image displayed on the user's field-of-view using the steps described below.

FIG. 4 illustrates a set 400 of icons used for tagging, in accordance with some embodiments. In one example, such as during an emergency operation, the user of the augmented reality display system 110 might hand-draw icons on a portable electronic device 120, tag, and communicate the hand-drawn icons to the rest of the emergency-response team members. For example, the user may hand-draw the icon 302 to communicate a “Danger” situation; hand-draw the icon 304 to denote a “fast move” action; hand-draw the icon 306 to represent a “1^{st} priority target”; hand-draw the icon 308 to represent a “2^{nd} priority target”; hand-draw the icon 310 to declare a target as being arrested; hand-draw the icon 312 to indicate that the user has lost tag on a particular suspect; hand-draw the icon 314 to request attack; hand-draw the icon 316 to indicate covert move 316; hand-draw the icon 318 to indicate simultaneous move; hand-draw the icon 320 to request back-up force; hand-draw the icon 322 to represent a “3^{rd} priority target.” The hand-drawn icons (shown in FIG. 4) may be tagged onto the image displayed on the user's field-of-view using the steps described below.

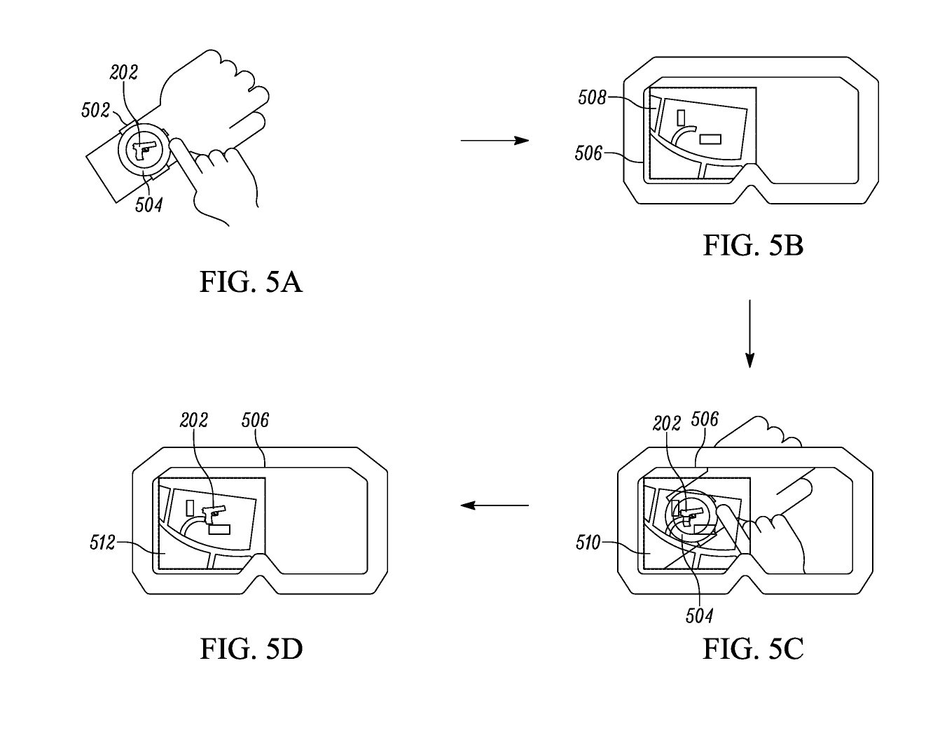

FIG. 5A illustrates an icon 202 displayed on a wrist worn electronic device 502 worn by the user of the augmented reality display system 110. In some embodiments, the wrist worn electronic device 502 includes a boundary 504 painted or printed along the periphery of the circular dial of the wrist worn electronic device 502. In some embodiments, the boundary 504 is displayed with or without modulation at the periphery of the display of the wrist worn electronic device 502. In some embodiments, the boundary 504 may be integrated with one or multiple infrared light emitting diodes (LED) that may be configured to emit modulated or non-modulated infrared signals. In some embodiments, the boundary 504 may be covered by an infrared reflective surface. In an example, boundary 504 may be a colored circle or a uniquely patterned dotted circle that contain a portable electronic device identifier. In other examples, a unique pattern may be provided on the wrist worn electronic device 502 to enable the augmented reality display system 110 to detect the presence of a portable electronic device 120 within its field-of-view. The boundary 504 enables the augmented reality display system 110 (shown in FIG. 1) to easily detect the display of wrist worn electronic device 502 when it is positioned within a field-of-view 506 (FIG. 5B) of the augmented reality display system 110 (shown in FIG. 1). The user of the augmented reality display system 110 selects the icon 202 from the set 300 (FIG. 3) to indicate the presence of armed suspect at a target location on the map 508 (FIG. 5B).

FIG. 5B illustrates a field-of-view 506 of an augmented reality display system 110 displaying a map 508, in accordance with some embodiments. In some embodiments, the user of the augmented reality display system 110 navigates her way through an emergency situation by utilizing the map 508 displayed on her field-of-view 506.

FIG. 5C illustrates tagging of the icon 202 (shown in FIG. 5A) onto the map 508 (shown in FIG. 5B), in accordance with some embodiments. In the example shown in FIG. 5C, the user of the augmented reality display system 110 positions the wrist worn electronic device 502 in such a manner to have the whole or substantially whole of the wrist worn electronic device 502 within her field-of-view 506. In some embodiments, the image sensor 119 (shown in FIG. 2) of the augmented reality display system 110 (FIG. 2) is configured to detect the boundary 504, which in turn enables locating and determining the icon 202 displayed within the field-of-view 506 of the user using the augmented reality display system 110.

FIG. 5D illustrates the map 508 displayed in FIG. 5B having the icon 202 tagged onto the map 508, in accordance with some embodiments. In some embodiments, the icon 202 may be tagged by the activation of a control device (not shown) in the augmented reality display system 110. In one example, the control device may have a touch-sensitive interface. In another example, the tagging of icon 202 may be executed by activating a control device within the wrist worn electronic device 502.

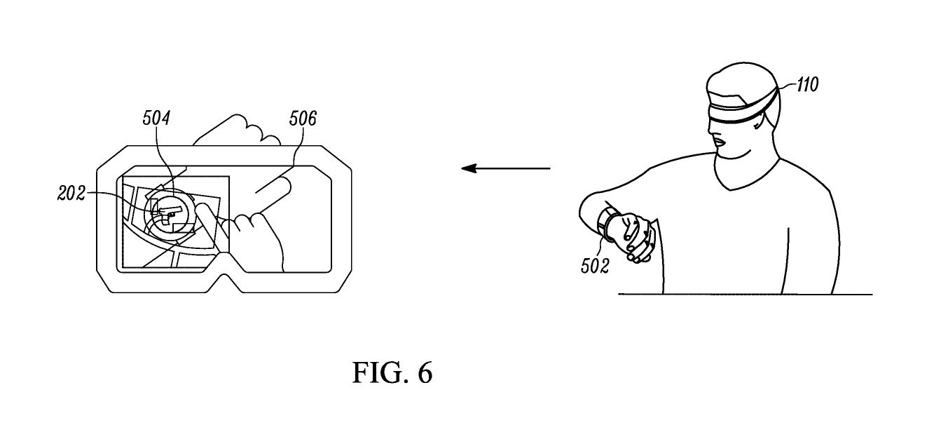

FIG. 6 illustrates repositioning of the icon shown in FIG. 5A in the field-of-view of the augmented reality display system 110, in accordance with some embodiments. In some embodiments, the user may reposition the display of the portable electronic device 120 within the field-of-view 506 by moving the wrist worn electronic device 502 along x-axis and y-axis. In some embodiments, the user may change at least one of the image characteristic of the image (for example, icon 202) displayed on the wrist worn electronic device 502 by moving the wrist worn electronic device 502 within the field-of-view 506 of the augmented reality display system 110. Adjusting at least one image characteristic, for example, a brightness, a color, a contrast, a shadow, etc., of the second image overlaid on the first image maybe accomplished by moving the wrist worn electronic device 502 within the field-of-view 506. In some embodiments, once the desired position, size, and/or other image characteristic of the image (for example icon 202) is determined the user may initiate capture of the icon (FIG. 3) or hand-drawn icon (FIG. 4) on the wrist worn electronic device 502 and render an image associated with the icon as an overlay on the map 508 displayed by the augmented reality display system 110. In some embodiments, the user may initiate capture of the icon 202 at the wrist worn electronic device 502 using methods known to those skilled in the art. In some embodiments, the user may initiate capture of the icon 202 at the augmented reality display system 110 using a user interface deploying methods known to those skilled in the art.

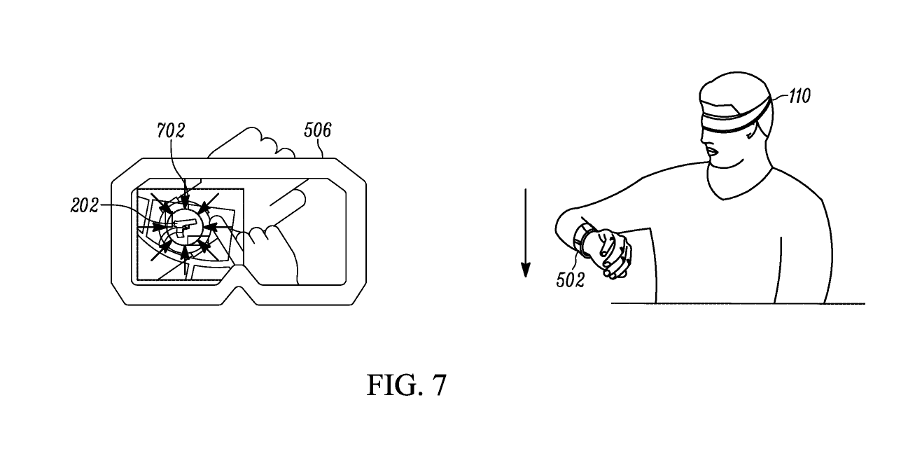

FIG. 7 illustrates resizing of the icon shown in FIG. 5A in the field-of-view 506 of the augmented reality display system 110 (shown in FIG. 1), in accordance with some embodiments. As shown in FIG. 7, the user may reposition the display of the wrist worn electronic device 502 within the field-of-view 506 of the augmented reality display system 110 by moving the wrist worn electronic device 502 further away from the augmented reality display system 110 to reduce the size (with pre-defined scaling rate) of the pre-defined icon overlaid at the augmented reality display system 110 field-of-view. Similarly, the user may move the wrist worn electronic device 502 nearer to the augmented reality display system 110 to increase the size (with pre-defined scaling rate) of the pre-defined icon overlaid at the augmented reality display system 110 field-of-view.

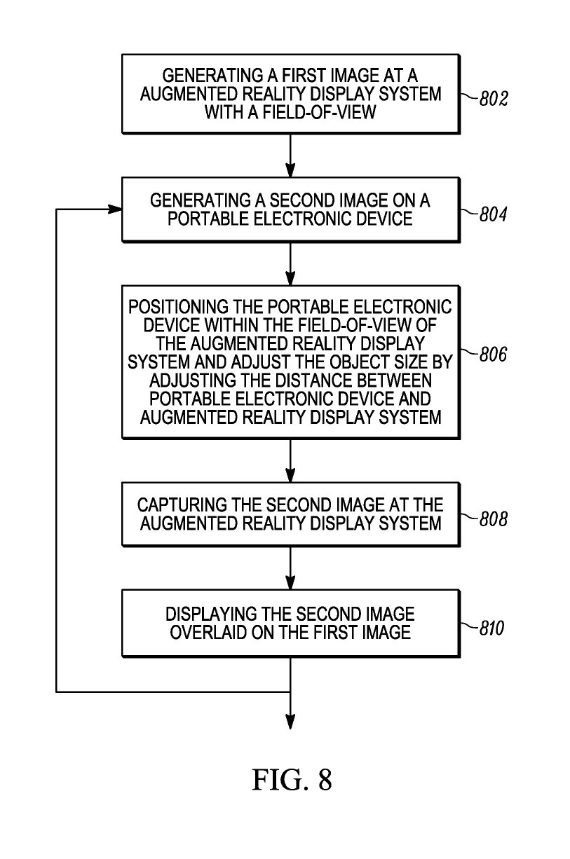

FIG. 8 is an exemplary flowchart of a method of communicating with an augmented reality display system 110 of FIG. 2, in accordance with some embodiments.

At block 802, the electronic processor 113 generates a first image at the augmented reality display system 110. In some embodiments, the first image includes a map 508 (FIG. 5B) of the immediate surroundings or the environment where the augmented reality display system 110 is located. In an example, the map 508 shows a location associated with the user of the augmented reality system 110. The electronic processor 113 generates the map 508 (FIG. 5B) by processing instructions stored in memory 118. In some embodiments, the electronic processor 113 automatically generates the map 508 (FIG. 5B) based on determining the location of the augmented reality display system 110 with a global positioning system. The map 508 (FIG. 5B) is displayed within a field-of-view 506 (FIG. 5B) for the user using the augmented reality display system 110. In some embodiments, a global positioning system may be integrated with either the augmented reality display system 110, the portable electronic device 120 or other radio or body worn smart devices to provide accurate maps that can be used by the user of the augmented reality display system 110.

At block 804, a second image is generated on the portable electronic device 120. In an example, the second image is generated when the user of the augmented reality display system 110 selects a particular icon 202 (such as an image of a “gun” shown in FIG. 5A) from a set 300 (FIG. 3) displayed on the portable electronic device 120. In the example shown in FIG. 5A, the portable electronic device 120 is a wrist worn electronic device 502 that displays icon 202. In some embodiments, the image generated at the portable electronic device 120 is hand-drawn on a touch-sensitive screen (not shown) in the portable electronic device 120. Some examples of the various icons that can be selected on the portable electronic device 120 are shown in FIG. 3. Some examples of the various hand-drawn signals that can be generated on the portable electronic device 120 are shown in FIG. 4. In some embodiments, when the second image is generated on the portable electronic device 120, the second image is automatically communicated to the augmented reality display system 110. In an example, the portable electronic device 120 is configured to take a picture of a suspect or a crime scene that may be tagged onto a map 508 displayed on the augmented reality display system 110.

At block 806, the portable electronic device 120 is positioned (FIG. 5C) within the field-of-view 506 for the user of the augmented reality display system 110. In the example shown in FIG. 5C, the wrist worn electronic device 502 is positioned towards the left side of the field-of-view such that the entire or substantial portion of the display of the wrist worn electronic device 502 is within the field-of-view for the user of the augmented reality display system 110. The position of the icon to be overlaid on the field-of-view of the augmented reality display system 110 may be adjusted in both the x-axis and y-axis and resized based on the relative position of the portable electronic device 120 to the augmented reality display system 110.

At block 808, the augmented reality display system 110 is configured to capture the second image (for example, icon 202) from the portable electronic device 120. In some embodiments, capturing the second image from the portable electronic device 120 includes transmitting at least one of the second image and a unique image identifier from the portable electronic device 120 to the augmented reality display system 110. In an example, capturing the second image from the portable electronic device includes transferring data associated with the second image (for example, icon 202) from the portable electronic device 120 to the augmented reality display system 110. In some embodiments, the image sensor 119 is configured to locate the portable electronic device 120 and capture the image within the field-of-view of the user and provide it to the electronic processor 113. In some embodiments, capturing the second image includes detecting a particular icon (in this example, icon 202, which is an image of a “gun”) and performing image processing to separate the icon from the image captured by the image sensor 119. In an example, the capture is performed automatically by the electronic processor 113. In some embodiments, the user initiates capturing of the second image onto the map 508 displayed on the augmented reality display system 110 by using a touch-sensitive interface (not shown) associated with the augmented reality display system 110. In an example, the augmented reality display system 110 is configured to automatically adjust the orientation of the icon that is being tagged on map 508.

At block 810, the augmented reality display system 110 is configured to display the second image (for example, icon 202) overlaid on the first image (for example, map 508). In some embodiments, the augmented reality display system 110 is configured to automatically communicate the icon 202 overlaid on the map 508 to several team members associated with the user of the augmented reality display system 110. In some embodiments, the hand-drawn icons (in FIG. 4) are automatically communicated to team members when they are overlaid on the map 508. As a result, all members of the user's team will be able to simultaneously view the same icons associated with particular locations on map 508. The method progresses to block 804 to generate another image at the portable electronic device 120 to be overlaid on an image displayed on the augmented reality display system 110.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (for example, comprising a processor) to perform a method as described and claimed herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of communicating with an augmented reality display system, the method comprising:
generating, with an electronic processor, a first image at the augmented reality display system, the augmented reality display system including a field-of-view;
generating a second image on a portable electronic device;
positioning the portable electronic device within the field-of-view of the augmented reality display system;
capturing the second image, by an image sensor, at the augmented reality display system; and
displaying the second image overlaid on the first image.

2. The method of claim 1, wherein the augmented reality display system is selected from a group consisting of a head mounted display system, a helmet display, an electronic eye glass, display goggles, and a wearable digital display.

3. The method of claim 1, wherein positioning the portable electronic device within the field-of-view of the augmented reality display system includes:
adjusting at least one image characteristic selected from a group consisting of a location, a size, a brightness, a color and a contrast of the second image overlaid on the first image by moving the portable electronic device within the field-of-view.

4. The method of claim 1, wherein capturing the second image includes transmitting at least one of the second image and a unique image identifier to the augmented reality display system.

5. The method of claim 1, wherein capturing the second image includes performing image processing on at least one of the first image and the second image.

6. The method of claim 1, wherein generating the first image includes generating a map of a location associated with a user of the augmented reality display system.

7. The method of claim 1, wherein generating the second image on the portable electronic device comprises generating a hand-drawn icon on the portable electronic device.

8. The method of claim 1, wherein capturing the second image on the augmented reality display system includes tagging an icon on the second image.

9. The method of claim 1, wherein capturing the second image comprises using a touch-sensitive interface associated with the augmented reality display system.

10. The method of claim 1, wherein capturing the second image comprises detecting, with the electronic processor, an icon on the augmented reality display system and automatically resizing the icon on the first image.

11. The method of claim 1, further comprising transferring data associated with the second image from the portable electronic device to the augmented reality display system.

12. An augmented reality display system comprising:
a display device including a field-of-view, wherein the display device configured to display a first image within the field-of-view;
an image sensor configured to capture a second image visible within the field-of-view, wherein the second image is generated on a portable electronic device external to the display device; and
an electronic processor configured to display the second image overlaid on the first image.

13. The augmented reality display system of claim 12, wherein the electronic processor is configured to tag the second image on to the first image.

14. The augmented reality display system of claim 12, wherein the first image includes a map of a location associated with the augmented reality display system.

15. The augmented reality display system of claim 12, wherein the second image includes an icon.

16. The augmented reality display system of claim 15, wherein the image sensor is configured to identify at least one of the icon and the hand-drawn icon displayed on the portable electronic device.

17. The augmented reality display system of claim 12, wherein the electronic processor is configured to adjust automatically an orientation of the second image overlaid on the first image.

18. The augmented reality display system of claim 12, wherein the portable electronic device is selected from a group consisting of a wearable electronic device, a hand held electronic device, a smart telephone, a digital camera, and a tablet computer.

19. The augmented reality display system of claim 12, wherein the augmented reality display system is selected from a group consisting of a head mounted display system, a helmet display, an electronic eye glass, display goggles and a wearable digital display.
